(19) United States
(12) Patent Application Publication
(10) Pub. No.: US 2019/0274274 A1
(43) Pub. Date: Sep. 12, 2019

(54) NON-CLAY BASED CLUMPING PET LITTERS AND METHODS OF MAKING AND USING SUCH PET LITTERS

(71) Applicant: NESTEC SA, VEVEY (CH)

(72) Inventor: Nathan Foster Huck, Jackson, MO (US)

(21) Appl. No.: 16/286,889

(22) Filed: Feb. 27, 2019

Related U.S. Application Data
(60) Provisional application No. 62/639,683, filed on Mar. 7, 2018.

(51) Int. Cl. A01K 1/015

(52) U.S. Cl. CPC A01K 1/0155

(57) ABSTRACT

A method of making a non-clay based clumping pet litter can include blending a natural material; compressing the blended natural material into pellets; grinding the pellets into granules; screening the granules to obtain a predetermined size range; and applying functional additives to the sized granules. The functional additives can include a clumping agent, mineral oil, and a surfactant. The natural material can be one or more of recycled paper, corrugate, and sawdust. The functional additives can further include a fragrance oil. The clumping agent can be guar gum, and the surfactant can be a polysorbate. In another aspect, a non-clay based clumping pet litter contains granules of compacted natural material enrobed by a coating containing a clumping agent, mineral oil that adheres the clumping agent to the granules, and a surfactant.

### CROSS REFERENCE TO RELATED APPLICATIONS

This application claims priority to U.S. Provisional Application No. 62/639,683 filed Mar. 7, 2018, the disclosure of which is incorporated herein by this reference.

### BACKGROUND

The present disclosure relates generally to a non-clay based clumping litter comprising granules of a natural material such as one or more of paper (e.g., recycled paper), corrugate or sawdust. The clumping litter further comprises one or more functional additives applied to the granules, preferably a clumping agent, mineral oil, and a surfactant.

Litter boxes are used by pets such as cats for elimination of urine and fecal matter. A litter box contains a layer of pet litter that receives the urine and fecal matter. The pet litter is granular, absorbent and either non-clumping or clumping. A clumping pet litter is a litter product in which the particles facilitate formation of clumps after the urine and fecal matter is deposited in the pet litter. The clumps are typically sifted from the litter box using a litter scoop and then discarded. Non-clumping pet litter is typically better at absorbing urine and thus removing urine odors, but replacing soiled non-clumping pet litter without emptying the entire box of litter can be difficult.

Traditional litters are clay-based and inherently heavy and dusty. Moreover, clay minerals must be mined and are thus non-renewable. Despite these drawbacks of density, dust, and non-renewability, clay-based litters remain popular because typical non-clay based litters are less effective in controlling malodors and in forming clumps with high degrees of integrity.

### SUMMARY

The present inventors found that a non-clay based animal litter comprising a raw material, for example, a natural product such as one or more of recycled paper, corrugate or sawdust, could be made by blending the raw material, then compressing the blended raw material into pellets, then grinding the pellets into granules, and then screening the granules to obtain a desired size range. Functional additives can be applied to the sized granules, for example, a clumping agent such as a hydrocolloid (e.g., guar gum), mineral oil for dust mitigation, a surfactant to improve absorption rate, and optionally a fragrance oil to enhance aroma appeal. The compression of the raw material into a pellet results in a composite particle having very low dust.

The present inventors found that the absorption rate of the resultant pellets was low, but grinding the pellets into granules improved the absorption rate. In order to enable the litter to clump, a clumping agent was used, for example guar gum. However, the clumping agent can be dusty and not adhere to the granules. Therefore, mineral oil can be included in the functional additives and thereby adhere the clumping agent to the granules. The adhered clumping agent could cause an issue with absorption due to the hydrophobic property of the mineral oil, but to counteract the water repellency and form clumps which do not extend to bottom of the box, a surfactant such as a polysorbate can be used.

Accordingly, in a general embodiment, the present disclosure provides a method of making a non-clay based clumping pet litter. The method comprises: blending a natural material; compressing the blended natural material into pellets; grinding the pellets into granules; screening the granules to obtain a predetermined size range; and applying functional additives to the sized granules, the functional additives comprising from about 0.50 wt. % to about 8.00 wt. % of a clumping agent, from about 0.5 wt. % to about 8.00 wt. % of mineral oil, and from about 0.01 wt. % to about 1.5 wt. % of a surfactant.

In an embodiment, the natural material is selected from the group consisting of woods, agricultural products and mixtures thereof.

In an embodiment, the natural material is selected from the group consisting of recycled paper, corrugate, sawdust and mixtures thereof.

In an embodiment, the granules consist of natural components only.

In an embodiment, the functional additives further comprise a fragrance oil.

In an embodiment, the clumping agent comprises a hydrocolloid.

In an embodiment, the surfactant comprises a polysorbate.

In an embodiment, the applying of the functional additives to the sized granules comprises applying the mineral oil to the sized granules to form granules at least partially coated with the mineral oil, then applying the clumping agent to the granules at least partially coated with the mineral oil.

In an embodiment, the applying of the functional additives to the sized granules comprises applying the mineral oil to the sized granules to form granules at least partially coated with the mineral oil, then applying the clumping agent to the granules at least partially coated with the mineral oil, and then applying the surfactant to the granules at least partially coated with the mineral oil and the clumping agent.

In an embodiment, the applying of the functional additives to the sized granules comprises applying a composition comprising the mineral oil and the surfactant to the sized granules to form granules at least partially coated with the mineral oil and the surfactant, and then applying the clumping agent to the granules at least partially coated with the mineral oil and the surfactant.

In an embodiment, the sized granules with the functional additives applied thereto are completely free of any clay.

In another embodiment, the present disclosure provides a non-clay based clumping pet litter comprising granules of compacted natural material enrobed by a coating comprising a clumping agent, a mineral oil that adheres the clumping agent to the granules, and a surfactant.

In an embodiment, the natural material is selected from the group consisting of woods, agricultural products and mixtures thereof.

In an embodiment, the natural material is selected from the group consisting of recycled paper, corrugate, sawdust and mixtures thereof.

In an embodiment, the granules consist of natural components only.

In an embodiment, the functional additives further comprise a fragrance oil.

In an embodiment, the clumping agent comprises a hydrocolloid.

In an embodiment, the surfactant comprises a polysorbate.

In an embodiment, the pet litter is completely free of any clay.

In another embodiment, the present disclosure provides a method of managing animal waste. The method comprises using a non-clay based clumping pet litter in a litter box, the non-clay based clumping pet litter comprising granules of compacted natural material enrobed by a coating comprising a clumping agent, a mineral oil that adheres the clumping agent to the granules, and a surfactant.

In an embodiment, the method comprises introducing a cat to the litter box in which the pet litter is positioned.

An advantage of one or more embodiments provided by the present disclosure is to provide improved pet litters.

Another advantage of one or more embodiments provided by the present disclosure is to provide methods of making improved pet litters.

A further advantage of one or more embodiments provided by the present disclosure is non-clay based clumping pet litters that are based on natural materials while providing low dust, good health for the pet and the home, and effective odor control.

Still another advantage of one or more embodiments provided by the present disclosure is to provide non-clay based clumping pet litters that have both a low density and good pet acceptance.

Yet another advantage of one or more embodiments provided by the present disclosure is to minimize pet litter dustiness.

Another advantage of one or more embodiments provided by the present disclosure is to reduce the depth of pet litter clumps.

A further advantage of one or more embodiments provided by the present disclosure is a non-clay based pet litter with good clump integrity, both short-term and long-term.

Still another advantage of one or more embodiments provided by the present disclosure is non-clay based clumping pet litters that is cost-effective to produce.

Additional features and advantages are described herein and will be apparent from the following Detailed Description and the Figures.

### BRIEF DESCRIPTION OF THE FIGURES

FIG. 1 is a photograph showing the effect of particle size on clumping as investigated in Example 1 disclosed herein.

FIG. 2 is a photograph showing the effect of exclusion of surfactant (left tray) vs. inclusion of surfactant (right tray) as investigated in Example 2 disclosed herein.

FIG. 3 (side view) and 4 (above view) are photographs which show clumping achieved by granules enrobed by mineral oil, 4.0 wt. % guar gum, and 0.5 wt. % Polysorbate 20 (upper right), granules enrobed by mineral oil, 3.5 wt. % guar gum, and 0.5 wt. % Polysorbate 20 (upper left), granules enrobed by mineral oil, 3.5 wt. % guar gum, and 0.25 wt. % Polysorbate 20 (lower left), and granules enrobed by mineral oil, 4.0 wt. % guar gum, and 0.0 wt. % Polysorbate 20 (lower right, less tight/more irregular clumping).

### DETAILED DESCRIPTION

Definitions

Some definitions are provided hereafter. Nevertheless, definitions may be located in the “Embodiments” section below, and the above header “Definitions” does not mean that such disclosures in the “Embodiments” section are not definitions.

All percentages expressed herein are by weight of the total weight of the composition unless expressed otherwise. As used herein, “about,” “approximately” and “substantially” are understood to refer to numbers in a range of numerals, for example the range of −10% to +10% of the referenced number, preferably −5% to +5% of the referenced number, more preferably −1% to +1% of the referenced number, most preferably −0.1% to +0.1% of the referenced number. All numerical ranges herein should be understood to include all integers, whole or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

As used in this disclosure and the appended claims, the singular forms “a,” “an” and “the” include plural referents unless the context clearly dictates otherwise. Thus, for example, reference to “a component” or “the component” includes two or more components.

The words “comprise,” “comprises” and “comprising” are to be interpreted inclusively rather than exclusively. Likewise, the terms “include,” “including” and “or” should all be construed to be inclusive, unless such a construction is clearly prohibited from the context. Nevertheless, the compositions disclosed herein may lack any element that is not specifically disclosed herein. Thus, a disclosure of an embodiment using the term “comprising” includes a disclosure of embodiments “consisting essentially of” and “consisting of” the components identified. A composition “consisting essentially of” contains at least 50 wt. % of the referenced components, preferably at least 75 wt. % of the referenced components, more preferably at least 85 wt. % of the referenced components, most preferably at least 95 wt. % of the referenced components.

The term “and/or” used in the context of “X and/or Y” should be interpreted as “X,” or “Y,” or “X and Y.” Similarly, “at least one of X or Y” should be interpreted as “X,” or “Y,” or “X and Y.” For example, “at least one of paper or sawdust” should be interpreted as “paper,” or “sawdust,” or “both paper and sawdust.”

Where used herein, the terms “example” and “such as,” particularly when followed by a listing of terms, are merely exemplary and illustrative and should not be deemed to be exclusive or comprehensive.

The terms “pet” and “animal” are used synonymously herein and mean any animal which can use a litter box, non-limiting examples of which include a cat, a dog, a rat, a ferret, a hamster, a rabbit, an iguana, a pig or a bird. The pet can be any suitable animal, and the present disclosure is not limited to a specific pet animal. The term “elimination” means urination and/or defecation by a pet.

As used herein, the term “litter” means any substance that can absorb animal urine and/or decrease odor from animal urine and/or feces. A “clumping litter” forms aggregates in the presence of moisture, the aggregates are distinct from the other litter in the litter box. A “clumping agent” binds adjacent particles when wetted. A “non-clumping litter” does not form distinct aggregates.

A “non-clay based” litter contains less than 1.0 wt. % of clay, preferably less than 0.1 wt. % clay, more preferably less than 0.01 wt. % clay, most preferably completely free of clay. Non-limiting examples of clay minerals that can be excluded from the litters disclosed herein include kaolin, smectite (e.g., montmorillonite smectite), illite, chlorite, sepiolite, and attapulgite.

The term “litter box” means any apparatus that can hold pet litter, for example a container with a bottom wall and one or more side walls, and/or any apparatus configured for litter to be positioned thereon, for example a mat or a grate. As a non-limiting example, a litter box may be a rectangular box having side walls that have a height of at least about six inches.

The term “mesh” is defined by the ASTM E-11 U.S.A. standard specification for sieves. As used herein, “size” of a particle refers to the length of the longest dimension of the particle.

The methods and devices and other advances disclosed herein are not limited to particular methodologies, protocols, and reagents because, as the skilled artisan will appreciate, they may vary. Further, the terminology used herein is for the purpose of describing particular embodiments only and does not limit the scope of that which is disclosed or claimed.

Unless defined otherwise, all technical and scientific terms, terms of art, and acronyms used herein have the meanings commonly understood by one of ordinary skill in the art in the field(s) of the present disclosure or in the field(s) where the term is used. Although any compositions, methods, articles of manufacture, or other means or materials similar or equivalent to those described herein can be used, the preferred devices, methods, articles of manufacture, or other means or materials are described herein.

### Embodiments

An aspect of the present disclosure is a method of making a non-clay based clumping pet litter. The method can comprise blending a natural material (e.g., one or more of recycled paper, corrugate or sawdust); compressing the blended raw material into pellets; grinding the pellets into granules; screening the granules to obtain a predetermined size range; and then applying functional additives to the sized granules, for example a clumping agent, mineral oil, a surfactant and optionally a fragrance oil. In some embodiments, the functional additives form a distinct layer having a boundary between the functional additives and the granules of natural material. Another aspect of the present disclosure is a non-clay based clumping pet litter made by this process.

In an embodiment, one or more of the functional additives can be applied separately from the other functional additives. For example, the mineral oil can be applied to the sized granules, then the clumping agent can be applied to the granules that are at least partially coated with the mineral oil, and then a composition comprising the surfactant and the optional fragrance oil can be added to the granules that are at least partially coated with the mineral oil and the clumping agent. As another example, a composition comprising the mineral oil and the surfactant can be applied to the sized granules, and then the clumping agent can be applied to the granules that are at least partially coated with the mineral oil and the surfactant. In another embodiment, each of the functional additives is applied to the granules together (i.e., as a single unitary composition). In an embodiment, the functional additives, whether applied sequentially or simultaneously, can be applied in the same coating apparatus.

In some embodiments, the pellets and/or the granules that become coated with the functional additives consist essentially of or consist of the natural materials. Non-limiting examples of suitable natural materials include woods, agricultural products (including agricultural by-products) and mixtures thereof. In an embodiment, the granules consist of natural components only and thus do not contain non-naturally occurring components. The term “natural components” includes chemically synthesized substances that are identical in structure to a naturally-occurring form of the substance. In one embodiment, the natural material and/or the granules comprise, consist essentially of, or consist of one or more of recycled paper, corrugate or sawdust or mixtures thereof. In another embodiment, the natural material, pellets and/or granules contain all three of recycled paper, corrugate, and sawdust. In another embodiment, the pet litter consists essentially of the granules of the compacted natural material, the clumping agent, the mineral oil and the surfactant.

Non-limiting examples of suitable woods include cedar, pine, oak, maple, eucalyptus, aspen, yucca, and combinations thereof. The woods can have any form suitable for functioning as an animal litter, e.g., chips, particles, pellets, crumbled pellets, sawdust, or crumbles.

Non-limiting examples of suitable agricultural products include alfalfa, corn, corn stalk, corn flour, oat hull, oat stalk, oat flour, barley hull, barley meal, barley stalk, barley flour, wheat hull, wheat straw, wheat flour, soybean hull, soybean meal, soybean floor, rye hull, rye meal, rye straw, rye flour, rice straw, rice hull, sorghum straw, sorghum hull, sunflower seeds, and combinations thereof. In some embodiments, the agricultural products comprise plant material, such as bamboo, lemongrass, switchgrass, catnip, oregano, parsley, rosemary, sage, thyme, valerian root, alyssum, chrysanthemum, honeysuckle, hops, lavender, apples, berries, orange peels, orange pulp, sunflower hulls, coffee, tea, or combinations thereof. In other embodiments, the agricultural products comprise sawdust, paper, corrugate, cellulose, corncob, corn kernel, Distillers Dried Grain (DDG), corn pellet, oaf pellet, barley pellet, wheat middlings, soybean pellet, rye pellet, rice grain, rice pellet, sorghum grain, sorghum pellet, or combinations thereof. In still other embodiments, the agricultural products comprise sunflower seed, almond, pistachio, walnut, pecan, hazelnut, peanut, acorn, wheat middlings, wheat straws, or combinations thereof.

In some embodiments, the sized granules can be from about 85.0 wt. % to about 96.0 wt. % of the non-clay based clumping litter. In other embodiments the sized granules are from about 90.0 wt. % to about 95.0 wt. % of the non-clay based clumping litter or about 92.20 wt. % of the non-clay based clumping litter. The corrugate (if any) in the granules can be from about 25.00 wt. % to 95.00 wt. % of the non-clay based clumping litter or about 23.05 wt. % of the non-clay based clumping litter; the sawdust (if any) in the granules can be from about 25.00 wt. % to 95.00 wt. % of the non-clay based clumping litter or about 23.05 wt. % of the non-clay based clumping litter; and the paper (if any) in the granules can be from about 25.00 wt. % to 95.00 wt. % of the non-clay based clumping litter or about 46.09 wt. % of the non-clay based clumping litter

In some embodiments, the clumping agent can be one or more of a hydrocolloid, for example one or more of a guar gum, xanthan gum, gum Arabic, gum acacia, carob gum, pectin, tara gum, a starch, or a modified starch. In one embodiment, the clumping agent is guar gum. In another embodiment, the clumping agent can be from about 0.50 wt. % to about 8.00 wt. % of the non-clay based clumping litter, from about 1.00 wt. % to about 6.00 wt. % of the non-clay based clumping litter, from about 2.00 wt. % to about 5.00 wt. % of the non-clay based clumping litter, or about 3.98 wt. % of the non-clay based clumping litter.

In some embodiments, the mineral oil can be any liquid mixture of C15 to C40 alkanes. In another embodiment, the mineral oil can be from about 0.5 wt. % to about 8.0 wt. % of the non-clay based clumping litter, from about 2.0 wt. % to about 5.0 wt. % of the non-clay based clumping litter, from about 3.0 wt. % to about 4.0 wt. % of the non-clay based clumping litter, or about 3.34 wt. % of the non-clay based clumping litter. In some embodiments, the mineral oil has a viscosity from about 10 cSt (@ 40° C.) to about 20 cSt (@ 40° C.). In one embodiment, the mineral oil is WO 15 mineral oil available from Petro Canada with a viscosity of about 15 cSt (@ 40° C.).

In some embodiments, the surfactant can be one or more non-ionic surfactants. In another embodiment, the non-ionic surfactant comprises ethoxylates, fatty alcohol ethoxylates, narrow-range ethoxylate, octaethylene glycol monododecyl ether, pentaethylene glycol monododecyl ether, alkylphenol ethoxylates, nonoxynols, Triton X-100, fatty acid ethoxylates, special ethoxylated fatty esters and oils, ethoxylated amines and/or fatty acid amides, polyethoxylated tallow amine, cocamide monoethanolamine, cocamide diethanolamine,terminally blocked ethoxylates, poloxamers, fatty acid esters of polyhydroxy compounds, fatty acid esters of glycerol, glycerol monostearate, glycerol monolaurate, fatty acid esters of sorbitol, sorbitan monolaurate, sorbitan monostearate, sorbitan tristearate, Tween 20, Tween 40, Tween 60, Tween 80, fatty acid esters of sucrose, alkyl polyglucosides, decyl glucoside, lauryl glucoside, octyl glucoside, amine oxides, lauryldimethylamine oxide, sulfoxides, dimethyl sulfoxide, phosphine oxides, and phosphine oxide. In one embodiment, the surfactant comprises a polysorbate, e.g., polyoxyethylene (20) sorbitan monolaurate (also known as Polysorbate 20, commercially available as Tween® 20. The surfactant can be from about 0.01 wt. % to about 1.5 wt. % of the non-clay based clumping litter, from about 0.05 wt. % to about 1.00 wt. %, from about 0.10 wt. % to about 1.00 wt. %, or about 0.25 wt. % to about 0.50 wt. % of the non-clay based clumping litter. In one embodiment the surfactant can be from about 0.30 wt. % to about 0.40 wt. % of the non-clay based clumping litter or about 0.36 wt. % of the non-clay based clumping litter.

In some embodiments, the compositions and methods of the present disclosure may optionally include a fragrance. In some embodiments, the fragrance can be from about 0.05 wt. % to about 0.60 wt. % of the non-clay based clumping litter, from about 0.10 wt. % to about 0.50 wt. %, or about 0.20 wt. % of the non-clay based clumping litter.

Non-limiting examples of suitable processes for blending the raw material include using a mixer, and combinations thereof. The present disclosure is not limited to a specific means of blending the raw material.

Non-limiting examples of suitable processes for compressing the blended raw material into pellets include compacting rolls; tumble/growth agglomeration; low-, medium-, or high pressure agglomeration; punch and die; roller press; high shear mixer granulator; extrusion; and combinations thereof. The present disclosure is not limited to a specific means of compressing the blended raw material into pellets, and the compressing can be any process that increases the density of the blend of raw material. Moreover, the term “pellet” does not require a specific shape, size or form. For example, the pellet can be a flattened pellet, a tablet or a puck.

The predetermined size range of the granules can be from about −5 to about +8 mesh, from about −5 to about +10 mesh, from about −5 to about +30 mesh, or from about −6 to about +30 mesh. Non-limiting examples of suitable processes for screening the granules to obtain a predetermined size range include using commercially available shaker screens thereof. The present disclosure is not limited to a specific means of screening the granules to obtain a predetermined size range.

Non-limiting examples of suitable processes for applying the functional additives to the sized granules include an enrober, a fluidized bed dryer, a semi-continuous centrifugal coater, a rotary coating and drying system, and combinations thereof.

Various additional additives may be optionally applied to the dried compacted particles. Non-limiting examples of suitable additional additives include an odor control agent, an anti-microbial agent, an anti-sticking agent, an agent for controlling pH, a dye, a coloring agent, a de-dusting agent, a disinfectant, and combinations thereof.

Another aspect of the present disclosure is a sealed package at least partially enclosing any of the embodiments of the pet litter disclosed herein, for example a sealed box or a sealed bag containing such pet litter. A further aspect of the present disclosure is a method of using a pet litter, the method comprising positioning at least a portion of a pet litter contained by a package into a litter box. The method can manage animal waste, such as cat urine. The method can comprise introducing a cat to the litter box comprising the pet litter, e.g., by positioning the litter box comprising the pet litter in a room periodically accessed by a cat.

### EXAMPLES

The following non-limiting examples are illustrative of embodiments of the non-clay based clumping pet litters provided by the present disclosure and advantages thereof.

### Example 1

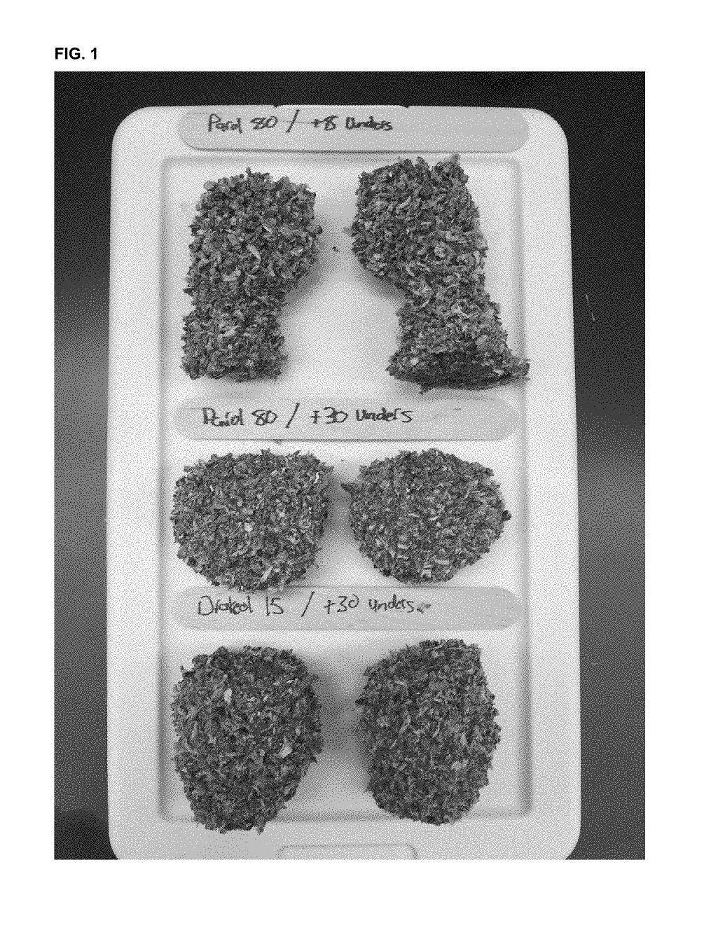

The present inventors investigated the effect of particle size on clumping by a litter base of sawdust, corrugate, and recycled paper that was enrobed with mineral oil, a surfactant (Tween® 20) and a clumping agent (guar gum). FIG. 1 is a photograph showing the results. The clumps at the top of the photo were from granules of non-clay based clumping litter having a size of +8 mesh and allowed for liquid channeling. The middle clumps and the bottom clumps were from non-clay based clumping litter having a size of +30 mesh and used different types of mineral oil relative to each other; these smaller granules had less channeling and tighter clumps.

### Example 2

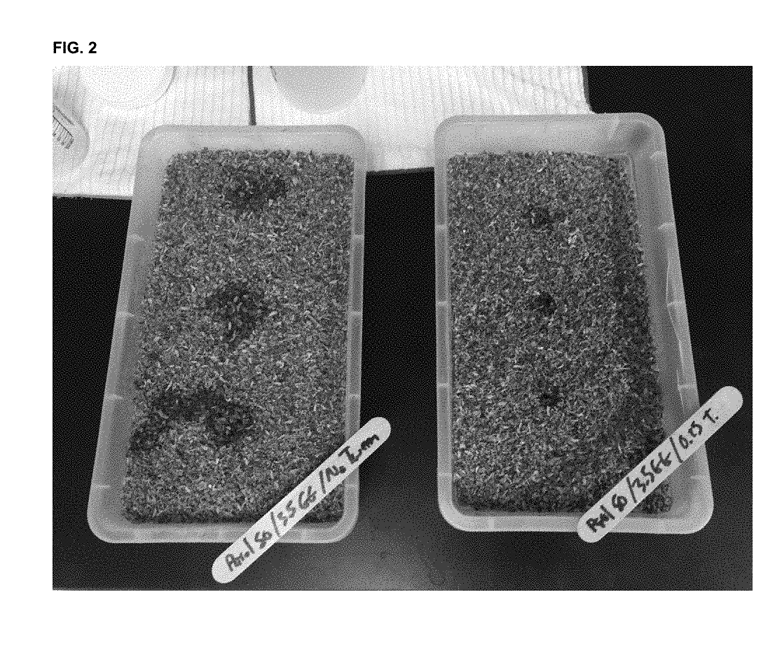

The present inventors compared clumping with a litter base of sawdust, corrugate, and recycled paper that was enrobed with mineral oil and clumping agent (guar gum) without surfactant (left tray in FIG. 2) and with surfactant (right tray in FIG. 2). As can be seen in this Figure, the non-clay based clumping litter without surfactant (left tray) allowed liquid to “run” irregularly on the surface rather than absorbing into the litter, creating weak areas of the clump which can break during removal. The non-clay based clumping litter with surfactant (right tray) achieved much tighter clumps and prevented spreading of the liquid.

### Example 3

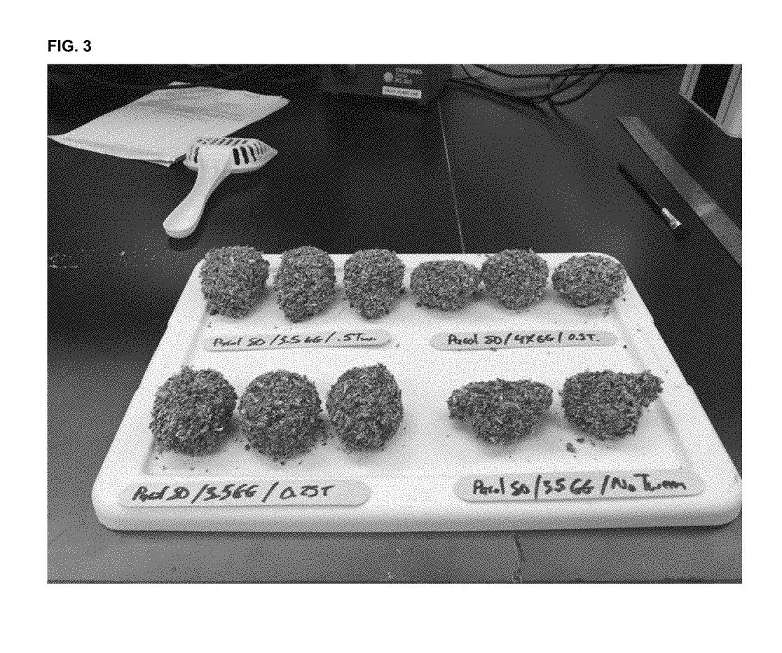

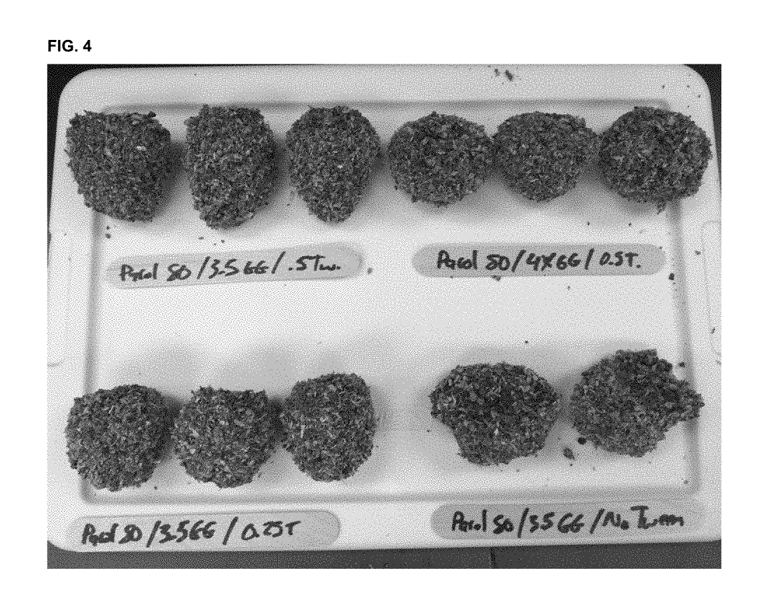

The present inventors investigated the effect of different amounts of the enrobing ingredients on clumping. FIGS. 3 and 4 are photographs from different angles of the results. As can be seen in these Figures, the tightest clumping was achieved by granules enrobed by mineral oil, 4.0 wt. % guar gum, and 0.5 wt. % Polysorbate 20 (upper right), as opposed to granules enrobed by mineral oil, 3.5 wt. % guar gum, and 0.5 wt. % Polysorbate 20 (upper left), granules enrobed by mineral oil, 3.5 wt. % guar gum, and 0.25 wt. % Polysorbate 20 (lower left), and granules enrobed by mineral oil, 4.0 wt. % guar gum, and 0.0 wt. % Polysorbate 20 (lower right, less tight/more irregular clumping).

### Example 4

Litter samples were prepared by blending and compacting raw materials into pellets. In this example recycled paper, corrugate and sawdust in approximately equal proportions by mass were combined and pelletized. Crushing and/or cutting the pellets produced granules with reduced particle size distribution and the screening fraction corresponding to about −6/+30 US Mesh size was selected. Additives were added to the −6/+30 material to provide compositions with about 0.50 wt. % to about 8.00 wt. % of a clumping agent, about 0.5 wt. % to about 8.0 wt. % of mineral oil, and about 0.20 wt. % to about 1.00 wt. % of a surfactant. Table 1 provides details for the specific compositions that were prepared.

TABLE 1

| | P2 - Standard | P1 - No Mineral | P3 - No |
|---|---|---|---|
| Ingredient | Formula | Oil | Surfactant |
| Crushed Litter Base | 92.38% | 95.72% | 92.68% |
| Mineral Oil | 3.34% | 0.00% | 3.34% |
| Guar | 3.98% | 3.98% | 3.98% |
| Surfactant (Tween 20) | 0.30% | 0.30% | 0.00% |
| Total | 100.00% | 100.00% | 100.00% |

### Example 5

The percent by mass of dust in a sample was determined by pouring a sample of known mass into a cylindrical test chamber approximately 20 inches in height and 4 inches in diameter. This test chamber had a 1 inch filter holder attached to it. A vacuum was pulled through this filter as the sample was poured into the chamber. Dust generated during the pouring operation was captured on the filter and the mass percent of dust was calculated as a mass ratio of dust:mass of sample. The dust masses collected for each sample were normalized by dust mass for a leading clay litter by dividing their percent dust mass by that of a leading clay litter.

TABLE 2

| | Dust % by | |
|---|---|---|
| | Sample Mass | |
| Sample | (%) | Normalized Dust |
| Commercial Clumping Litter | 0.002% | 1.00 |
| P1- No Mineral Oil | 0.016% | 8.24 |
| P2- Standard Formula | 0.007% | 3.67 |

### Example 6

The bulk density of a sample was measured using a Seedburo® filling hopper (1¼ in diameter opening), stand, and pint sized (550.06 cm³ dry volume) sample cup. The sample litter was poured into the filling hopper until it was full and then transferred to the pint cup until the cup was full and overflowing. A straight edge was used to remove excess product from the top of the cup and level the cup contents with the rim of the cup. The cup with sample litter was weighed. The weighing was repeated three times. Exemplary density ranges for compositions of the present disclosure are provided in Table 4.

TABLE 3

| | Bulk Density |
|---|---|
| Sample | (lb/ft³) |
| Commercial Clumping Litter | 57.3 |
| P2- Standard Formula | 24.9 |

TABLE 4
Density Range (lb/ft³)

| Sample | Low | High |
|---|---|---|
| Pellets | 25.0 | 32.0 |
| Crushed Pellets | 16.0 | 20.0 |
| Finished Product w/Additives | 18.0 | 32.0 |

### Example 7

The clump formation absorption (%) and clump cohesion (%) of sample litters were examined according to the following procedure. An 8″ diameter sieve with ¾″ mesh was stacked on top of a sieve pan and placed on the bottom of a support stand. A trap door assembly was attached to the support stand and positioned ten inches above ¾″ sieve. A representative sample of litter was added to a litter testing pan. About 25 ml aliquots of a saline solution was dispensed onto the sample litter surface to form a clump. The clump was removed from the sample litter and its mass recorded as W1. The clump was then centered on the trap door mechanism assembled and allowed fall onto the ¾″ test sieve. The clump or largest piece was weighed and the mass recorded as W2. The Percentage of Cohesion value was calculated using the following formula:

Percentage of Cohesion=[W2 (final weight)/W1 (initial weight)]×100

The Clump Formation Absorption value was calculated using the following formula:

Clump Formation Absorption (%)=((Mass of Liquid Added)/(W1−Mass of Liquid Added)×100)

in which the Mass of Liquid Added was calculated by multiplying the quantity of liquid (mL) by its density.

TABLE 5

| | Clump | |
|---|---|---|
| | Cohesion | Clump Formation |
| Sample | Average (%) | Absorption (%) |
| Commercial Clumping Litter | 98.0% | 45.5% |
| P3 - No Tween | 94.2% | 87.6% |
| P2- Standard Formula | 96.6% | 93.1% |

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method of making a non-clay based clumping pet litter, the method comprising:
blending a natural material;
compressing the blended natural material into pellets;
grinding the pellets into granules;
screening the granules to obtain a predetermined size range; and
applying functional additives to the sized granules, the functional additives comprising from about 0.50 wt. % to about 8.00 wt. % of a clumping agent, from about 0.5 wt. % to about 8.0 wt. % of mineral oil, and from about 0.01 wt. % to about 1.5 wt. % of a surfactant.

2. The method of claim 1, wherein the natural material is selected from the group consisting of woods, agricultural products and mixtures thereof.

3. The method of claim 1, wherein the natural material is selected from the group consisting of recycled paper, corrugate, sawdust and mixtures thereof.

4. The method of claim 1, wherein the granules consist of natural components only.

5. The method of claim 1, wherein the functional additives further comprise a fragrance oil.

6. The method of claim 1, wherein the clumping agent comprises a hydrocolloid.

7. The method of claim 1, wherein the surfactant comprises a polysorbate.

8. The method of claim 1, wherein the applying of the functional additives to the sized granules comprises applying the mineral oil to the sized granules to form granules at least partially coated with the mineral oil, and then applying the clumping agent to the granules at least partially coated with the mineral oil.

9. The method of claim 1, wherein the applying of the functional additives to the sized granules comprises applying the mineral oil to the sized granules to form granules at least partially coated with the mineral oil, then applying the clumping agent to the granules at least partially coated with mineral oil to form granules at least partially coated with the mineral oil and the clumping agent, and then applying the surfactant to the granules at least partially coated with the mineral oil and the clumping agent.

10. The method of claim 1, wherein the applying of the functional additives to the sized granules comprises applying a composition comprising the mineral oil and the surfactant to the sized granules to form granules at least partially coated with the mineral oil and the surfactant, and then applying the clumping agent to the granules at least partially coated with the mineral oil and the surfactant.

11. The method of claim 1, wherein the sized granules with the functional additives applied thereto are completely free of any clay.

12. A non-clay based clumping pet litter comprising granules of compacted natural material enrobed by a coating comprising from about 0.50 wt. % to about 8.00 wt. % of a clumping agent, from about 0.5 wt. % to about 8.0 wt. % of mineral oil that adheres the clumping agent to the granules, and from about 0.01 wt. % to about 1.5 wt. % of a surfactant.

13. The pet litter of claim 12, wherein the natural material is selected from the group consisting of woods, agricultural products and mixtures thereof.

14. The pet litter of claim 12, wherein the natural material is selected from the group consisting of recycled paper, corrugate, sawdust and mixtures thereof.

15. The pet litter of claim 12, wherein the granules consist of natural components only.

16. The pet litter of claim 12, further comprising a fragrance oil.

17. The pet litter of claim 16, wherein the fragrance oil is present in an amount from about 0.05 wt. % to about 0.6 wt. %.

18. The pet litter of claim 12, wherein the clumping agent comprises a hydrocolloid.

19. The pet litter of claim 12, wherein the surfactant comprises a polysorbate.

20. The pet litter of claim 12, which is completely free of any clay.
